(19) United States
(12) Patent Application Publication
(10) Pub. No.: US 2022/0408861 A1
(43) Pub. Date: Dec. 29, 2022

(54) Face Mask Assembly

(71) Applicant: Andrey Gavryush, Sacramento, CA (US)

(72) Inventor: Andrey Gavryush, Sacramento, CA (US)

(21) Appl. No.: 17/357,524

(22) Filed: Jun. 24, 2021

(51) Int. Cl. A41D 13/11; A62B 23/02; A62B 18/08; A62B 18/02; A62B 9/06

(52) U.S. Cl. CPC A41D 13/1107; A62B 23/025; A62B 18/084; A62B 18/025; A62B 9/06

(57) ABSTRACT

A face mask assembly includes a face mask that has a concave shape such that the face mask covers the user's mouth and the user's nose when the face mask is worn. A pad is integrated into the face mask to extend across the user's nose when the face mask is worn. The pad is comprised of an air impermeable material to inhibit air exhaled by the user from passing between the face mask and the user's nose thereby inhibiting eyeglasses worn by the user from is fogged. A bendable strip is integrated into the pad thereby facilitating the bendable strip to retain the pad in a preferred shape to conform to the shape of the user's nose.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to face mask devices and more particularly pertains to a new face mask device for inhibiting exhaled air from fogging eyeglasses worn by a user. The device includes an air impermeable pad that is strategically positioned on the face mask such that the air impermeable pad rests on the user's nose when the face mask device is worn. Additionally, a bendable strip is integrated into the pad for shaping the pad to facilitate the pad to conform to the shape of the user's nose.

### (2) Description of Related Art Including Information Disclosed Under 37 CFR 1.97 and 1.98

The prior art relates to face mask devices including a face mask, which as a rectangular shape, and which has an air impermeable element that extends across a full width of the mask to inhibit fogging of eyeglasses when the face mask is worn. The prior art discloses a variety of face masks that include air vents to inhibit air from passing upwardly over the user's nose and fogging eyeglasses. The prior art discloses a face mask that includes a nose pad and an inner layer that is doubled back over the nose pad to inhibit fogging of eyeglasses. The prior art also discloses a face mask that has a moisture absorbing element for inhibiting fogging of eyeglasses.

### BRIEF SUMMARY OF THE INVENTION

An embodiment of the disclosure meets the needs presented above by generally comprising a face mask that has a concave shape such that the face mask covers the user's mouth and the user's nose when the face mask is worn. A pad is integrated into the face mask to extend across the user's nose when the face mask is worn. The pad is comprised of an air impermeable material to inhibit air exhaled by the user from passing between the face mask and the user's nose thereby inhibiting eyeglasses worn by the user from is fogged. A bendable strip is integrated into the pad thereby facilitating the bendable strip to retain the pad in a preferred shape to conform to the shape of the user's nose.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a face mask assembly according to an embodiment of the disclosure.

FIG. 2 is a front view of an embodiment of the disclosure.

FIG. 3 is a back view of an embodiment of the disclosure.

FIG. 4 is a top view of an embodiment of the disclosure.

FIG. 5 is a perspective in-use view of an embodiment of the disclosure.

FIG. 6 is a front view of an alternative embodiment of the disclosure.

### DETAILED DESCRIPTION OF THE INVENTION

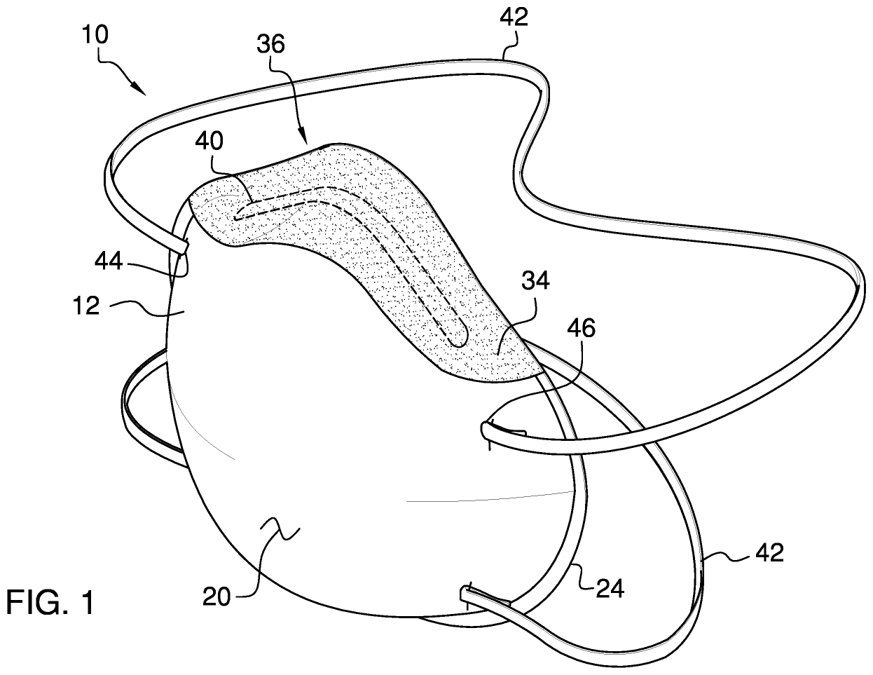

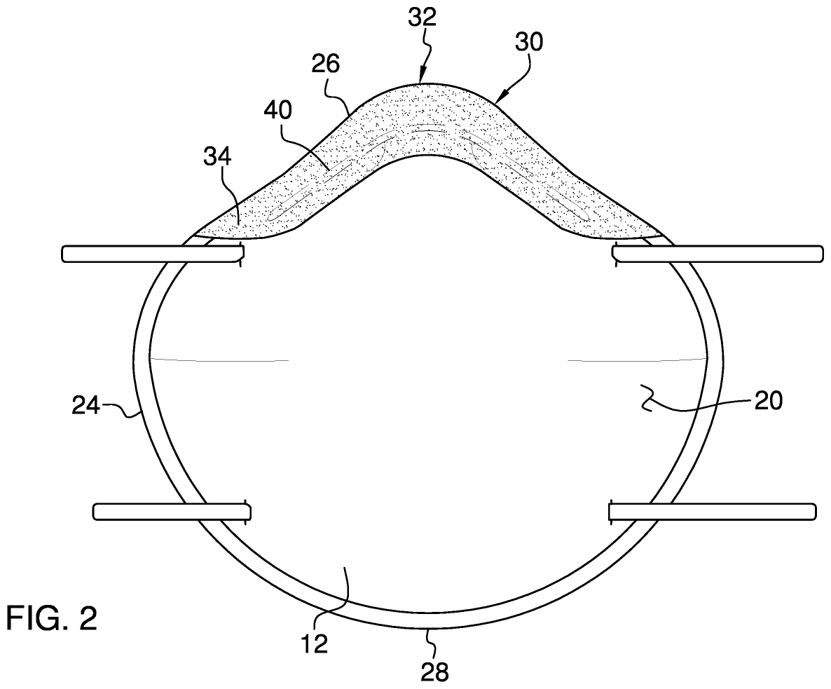

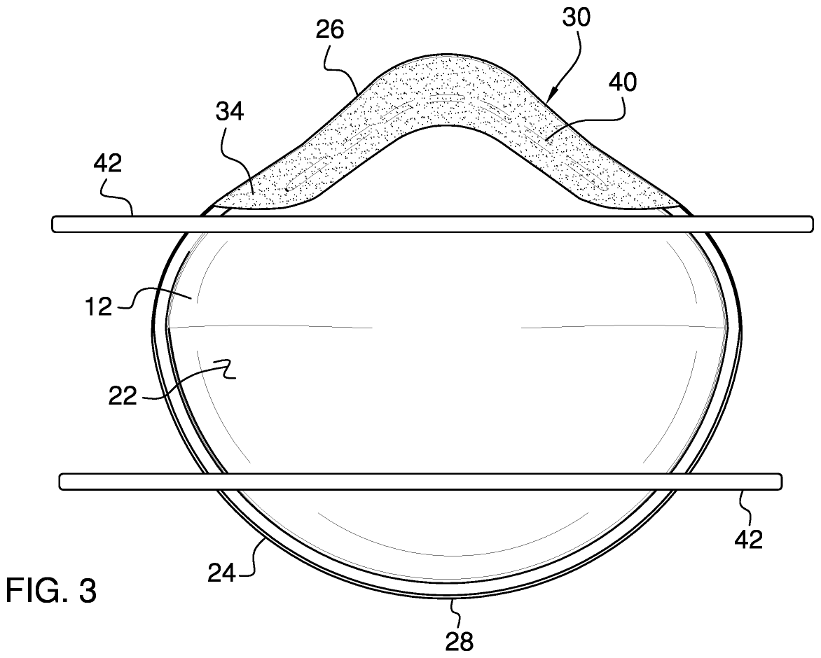

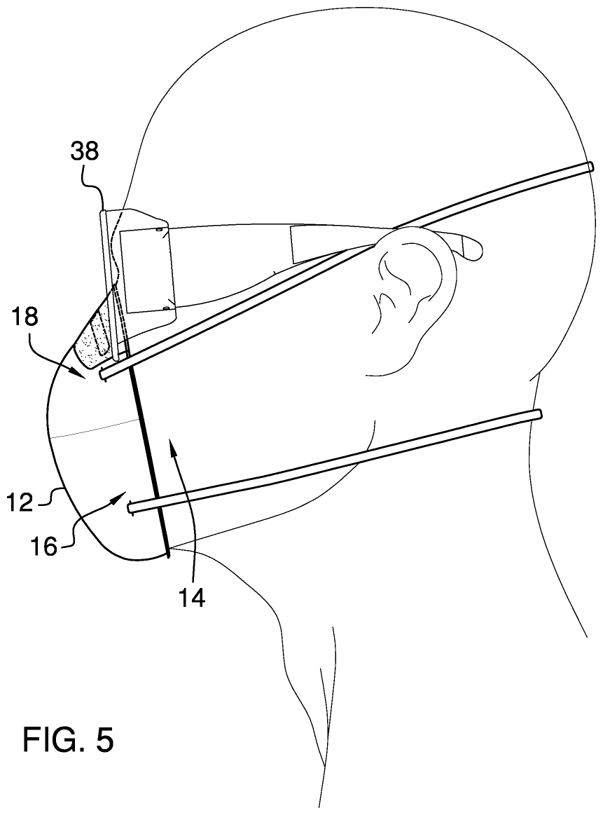

With reference now to the drawings, and in particular to FIGS. 1 through 6 thereof, a new face mask device embodying the principles and concepts of an embodiment of the disclosure and generally designated by the reference numeral 10 will be described.

As best illustrated in FIGS. 1 through 6, the face mask assembly 10 generally comprises a face mask 12 that has a concave shape for wearing on a user's face 14 such that the face mask 12 covers the user's mouth 16 and the user's nose 18. The face mask 12 is comprised of a particulate filtering material to filter particles from air that is breathed by the user. The particulate filtering material may comprise N95 respirator material or other material that is approved by Occupational Safety and Health Administration for use on hazardous job sites or the like.

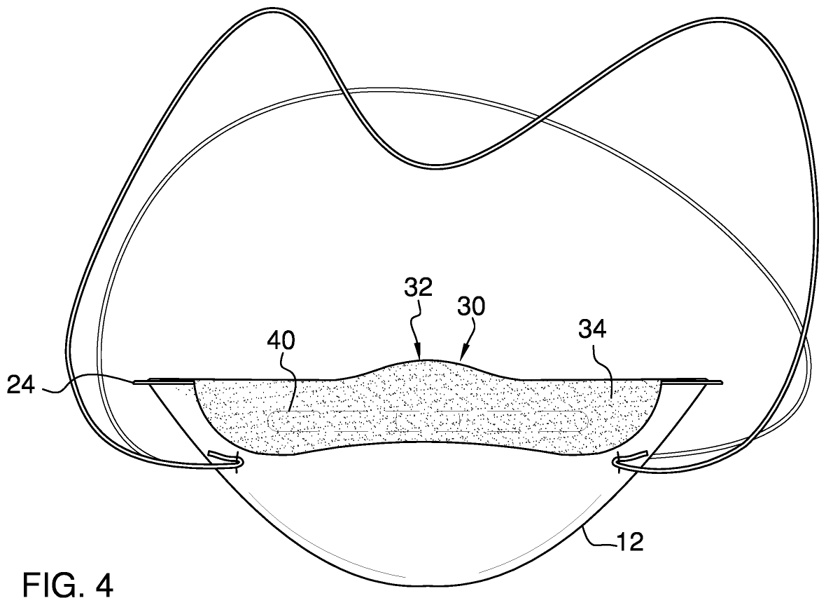

The face mask 12 has a front surface 20, a back surface 22 and a perimeter edge 24 extending between the front surface 20 and the back surface 22, and the back surface 22 is concavely arcuate with respect to the perimeter edge 24. The perimeter edge 24 is substantially arcuate about a center point of the back surface 22, and the perimeter edge 24 has a top side 26 and a bottom side 28. The perimeter edge 24 curves upwardly beyond a circumference defined by the perimeter edge 24 to define a lobe 30 on the top side 26 to accommodate the user's nose 18 when the face mask 12 is worn. As is most clearly shown in FIG. 4, the top side 26 of the perimeter edge 24 may curve rearwardly from the face mask 12 at an apex 32 of the lobe 30 such that the lobe 30 extends substantially upwardly on the user's nose 18. Each of the front surface 20 and the back surface 22 is flattened adjacent to the perimeter edge 24 around a substantial circumference of the face mask 12.

A pad 34 is integrated into the face mask 12 and the pad 34 is strategically positioned on an upper threshold 36 of the face mask 12 to extend across the user's nose 18 when the face mask 12 is worn. The pad 34 is comprised of an air impermeable material to inhibit air exhaled by the user from passing between the face mask 12 and the user's nose 18 thereby inhibiting eyeglasses 38 worn by the user from is fogged. The eyeglasses 38 might be protective eyewear, corrective lenses or other types of eyewear. The pad 34 is aligned with the top side 26 of the perimeter of the face mask 12 has the pad 34 extending downwardly along opposite sides of the lobe 30. In this way the pad 34 can rest against the user's nose 18 when the face mask 12 is worn. The pad 34 might be comprised of rubber or other similar type of material that is both air impermeable and compressible to enhancing comfort for the user.

A bendable strip 40 is provided and the bendable strip 40 is integrated into the face mask 12. The bendable strip 40 is aligned with the pad 34 thereby facilitating the bendable strip 40 to retain the pad 34 in a preferred shape to facilitate the pad 34 to conform to the shape of the user's nose 18. Moreover, the bendable strip 40 is comprised of a bendable material such that the bendable strip 40 remains in whatever shape into which the bendable strip 40 is bent. The bendable strip 40 is positioned within the pad 34 such that the bendable strip 40 is inhibited from contacting the user's nose 18.

A pair of straps 42 is each coupled to the face mask 12 and each of the straps 42 can be positioned around the user's head 44 for retaining the face mask 12 on the user's face 14. Each of the straps 42 has a first end 46 and a second end 48. and each of the first end 46 and the second end 48 of each of the straps 42 is attached to the second surface of the face mask 12 such that each of the straps 42 forms a closed loop with the face mask 12. The first end 46 and the second end 48 of each of the straps 42 are positioned on opposite sides of the face mask 12 with respect to each other. Additionally, each of the straps 42 is positioned adjacent to a respective one of the pad 34 and the bottom side 28 of the perimeter edge 24 of the face mask 12. Each of the straps 42 might be comprised of a resiliently stretchable material such as elastic or other similar type of material.

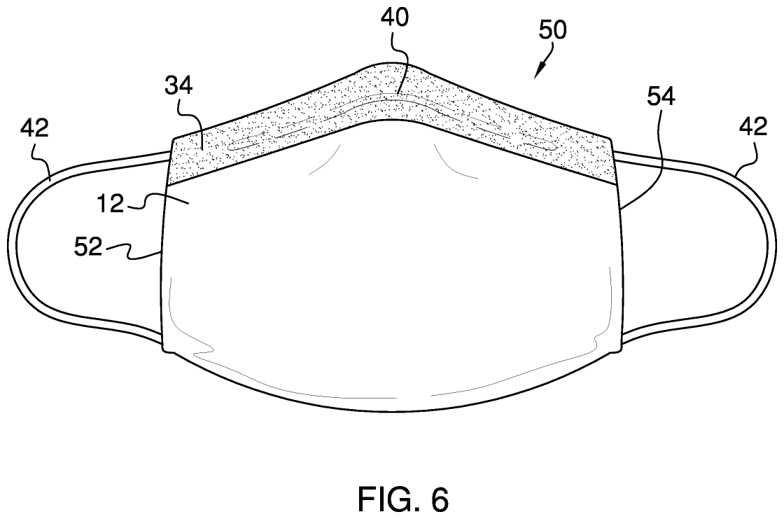

In an alternative embodiment 50 as is most clearly shown in FIG. 6, the face mask 12 may comprise a flexible panel. Each of a first lateral side 52 and a second lateral side 54 of the perimeter edge 24 of the face mask 12 may extend in a straight line between the top side 26 and the bottom side 28 of the perimeter edge 24. The pad 34 may extend along a full length of the top side 26 such that the pad 34 extends between the first lateral side 52 and the second lateral side 54. Additionally, each of the straps 42 might extend away from a respective one of the first lateral side 52 and the second lateral side 54, forming a closed loop with the respective first lateral side 52 and second lateral side 54.

In use, the face mask 12 is worn on the user's face 14 when the user is working in an area that exposes the user to a potentially hazardous level of airborne particles. The bendable strip 40 is bent such that the pad 34 fully conforms to the user's nose 18. In this way the pad 34 inhibits air exhaled by the user from passing between the face mask 12 and the user's nose 18. Thus, the eyeglasses 38 that are worn by the user will not become fogged as is common with existing face masks. Additionally, the eyeglasses 38 that are worn by the user will not rest higher on the user's face 14 than they were designed to. In this way prescription eyeglasses 38 will properly correct the user's vision. Additionally, safety eyeglasses will remain the preferred distance from the user's face 14 to ensure the user gains the maximum protection from the safety eyeglasses 38.

With respect to the above description then, it is to be realized that the optimum dimensional relationships for the parts of an embodiment enabled by the disclosure. to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A face mask assembly having a nose barrier integrated therein thereby inhibiting exhaled air from fogging eyeglasses worn by a user, said assembly comprising:
a face mask having a concave shape wherein said face mask being configured to be worn on a user's face such that said face mask covers said user's mouth and said user's nose, said face mask being comprised of a particulate filtering material wherein said face mask being configured to filter particles from air being breathed by said user;
a pad being integrated into said face mask, said pad being strategically positioned on an upper threshold of said face mask wherein said pad being configured to extend across said user's nose when said face mask being worn, said pad being comprised of an air impermeable material wherein said pad being configured to inhibit air exhaled by said user from passing between said face mask and said user's nose thereby inhibiting eyeglasses worn by said user from being fogged;
a bendable strip being integrated into said face mask, said bendable strip being aligned with said pad thereby facilitating said bendable strip to retain said pad in a preferred shape wherein said bendable strip being configured to facilitate said pad to conform to said shape of said user's nose; and
a pair of straps, each of said straps being coupled to said face mask wherein each of said straps being configured to be positioned around said user's head for retaining said face mask on said user's face.

2. The assembly according to claim 1, wherein said face mask has a front surface, a back surface and a perimeter edge extending between said front surface and said back surface, said back surface being concavely arcuate with respect to said perimeter edge, said perimeter edge being substantially arcuate about a center point of said back surface, said perimeter edge having a top side, said perimeter edge curves upwardly beyond a circumference defined by said perimeter edge to define a lobe on said top side wherein said lobe being configured to accommodate said user's nose when said mask being worn.

3. The assembly according to claim 2, wherein said pad being aligned with said top side of said perimeter of said face mask having said pad extending downwardly along opposite sides of said lobe wherein said pad being configured to rest against said user's nose when said face mask being worn.

4. The assembly according to claim 1, wherein said bendable strip being comprised of a bendable material such that said bendable strip remains in whatever shape into which said bendable strip being bent, said bendable strip being positioned within said pad wherein said bendable strip being configured to be inhibited from contacting said user's nose.

5. The assembly according to claim 2, wherein each of said straps having a first end and a second end, each of said first end and said second end of each of said straps being attached to said second surface of said face mask such that each of said straps forms a closed loop with said face mask, said first end and said second end of each of said straps being positioned on opposite sides of said face mask with respect to each other, each of said straps being positioned adjacent to a respective one of said pad and said bottom side of said perimeter edge of said face mask.

6. A face mask assembly having a nose barrier integrated therein thereby inhibiting exhaled air from fogging eyeglasses worn by a user, said assembly comprising:
a face mask having a concave shape wherein said face mask being configured to be worn on a user's face such that said face mask covers said user's mouth and said user's nose, said face mask being comprised of a particulate filtering material wherein said face mask being configured to filter particles from air being breathed by said user, said face mask having a front surface, a back surface and a perimeter edge extending between said front surface and said back surface, said back surface being concavely arcuate with respect to said perimeter edge, said perimeter edge being substantially arcuate about a center point of said back surface, said perimeter edge having a top side and a bottom side, said perimeter edge curving upwardly beyond a circumference defined by said perimeter edge to define a lobe on said top side wherein said lobe being configured to accommodate said user's nose when said mask being worn;
a pad being integrated into said face mask, said pad being strategically positioned on an upper threshold of said face mask wherein said pad being configured to extend across said user's nose when said face mask being worn, said pad being comprised of an air impermeable material wherein said pad being configured to inhibit air exhaled by said user from passing between said face mask and said user's nose thereby inhibiting eyeglasses worn by said user from being fogged, said pad being aligned with said top side of said perimeter of said face mask having said pad extending downwardly along opposite sides of said lobe wherein said pad being configured to rest against said user's nose when said face mask being worn;
a bendable strip being integrated into said face mask, said bendable strip being aligned with said pad thereby facilitating said bendable strip to retain said pad in a preferred shape wherein said bendable strip being configured to facilitate said pad to conform to said shape of said user's nose, said bendable strip being comprised of a bendable material such that said bendable strip remains in whatever shape into which said bendable strip being bent, said bendable strip being positioned within said pad wherein said bendable strip being configured to be inhibited from contacting said user's nose; and
a pair of straps, each of said straps being coupled to said face mask wherein each of said straps being configured to be positioned around said user's head for retaining said face mask on said user's face, each of said straps having a first end and a second end, each of said first end and said second end of each of said straps being attached to said second surface of said face mask such that each of said straps forms a closed loop with said face mask, said first end and said second end of each of said straps being positioned on opposite sides of said face mask with respect to each other, each of said straps being positioned adjacent to a respective one of said pad and said bottom side of said perimeter edge of said face mask.
